(19) United States
(12) Patent Application Publication
(10) Pub. No.: US 2011/0059728 A1
(43) Pub. Date: Mar. 10, 2011

(54) CREATING AND GIVING PERSONALIZED IMAGE PRODUCT USING WIRELESS DEVICES

(76) Inventor: John David Poisson, San Francisco, CA (US)

(21) Appl. No.: 12/706,828

(22) Filed: Feb. 17, 2010

Related U.S. Application Data
(60) Provisional application No. 61/241,354, filed on Sep. 10, 2009.
(60) Provisional application No. 61/265,643, filed on Dec. 1, 2009.

(51) Int. Cl. H04M 3/42; G06Q 30/00; G06Q 50/00; H04M 1/00

(52) U.S. Cl. 455/414.1; 455/556.1; 705/20

(57) ABSTRACT

A method for a camera phone user to create a photo gift includes receiving a design for an image-based gift product from an image-capture device capable of wireless communication operated by a first user, the image-based product incorporating an image captured by the image-capture device, sending a message via a wireless router system about the image-based gift product from the first user to a second user, receiving a physical address from the second user by the wireless router system after the message is received by the second user, manufacturing the image-based gift product by a printing and finishing facility in communication with the wireless router system, and shipping the image-based gift product to the physical address.

### CROSS-REFERENCES TO RELATED INVENTIONS

The present invention claims priority to commonly assigned U.S. Provisional Patent Application Ser. No. 61/241,354, titled “Wireless imaging for personalized image product”, filed Sep. 10, 2009, U.S. Provisional Patent Application Ser. No. 61/265,643, titled “Flexible user interface for image manipulation for an image product”, filed Dec. 1, 2009, and U.S. patent application Ser. No. 12/683,557, titled “Flexible user interface for image manipulation for an image product”, filed Jan. 7, 2010, the disclosures of which are incorporated herein by reference.

### BACKGROUND

In recent years, photography has been rapidly transformed by digital imaging technologies. Digital images can be captured by digital cameras or camera phones, stored in computers, and viewed on electronic display devices. Digital images can be uploaded from a user's computer device to a central sever provided by an image service provider such as Shutterfly, Inc. The user can store, organize, edit, enhance, and share digital images at the central network location using a web browser. A user can also design and order image-based products from the image service provider for the user herself or as photo gifts to others. A high degree of personalization can be achieved to make the image-based products memorable to the user and to the photo gift recipients.

The creation of personalized image products, however, can take considerable amount of time and effort. In addition, user interface for creating personalized image products are not available on small mobile devices on wireless camera phones. There is therefore a need for more convenient methods for creating personalized imaging products on camera phone and other digital imaging devices.

### SUMMARY

In one aspect, the present application relates to a system for a camera phone user to create a photo gift. The system includes a wireless router system that can communicate with a plurality of camera phones each operated by a different user, wherein the wireless router system can receive a data structure from a first camera phone operated by a first user, the data structure comprising a data object that defines a picture strip that includes a row of images and has a length-to-width ratio in a range between 2.5 and 6, and the data structure further specifying a recipient for the picture strip; a server that can send a message to the recipient for the picture strip and to receive a physical address from the recipient where the picture strip is to be sent; and a printing and finishing facility in communication with the server, the printing and finishing facility that can produce the picture strip in accordance to the data structure.

In another aspect, the present application relates to a method for a camera phone user to create a photo gift. The method includes capturing an image, by a first user, with an image-capture device capable of wireless communication; creating an image-based gift product incorporating the image using the image-capture device; sending a message about the image-based gift product from the first user to a second user; receiving a physical address from the second user after the message is received by the second user; manufacturing the image-based gift product; and shipping the image-based gift product to the physical address received from the second user.

In another aspect, the present application relates to a method for automatically creating a picture strip. The method includes defining a picture strip format having a predetermined number of images; sorting a plurality of images into one or more groups each comprising the predetermined number of images; automatically creating a data structure for a picture strip comprising a group of images; storing the data structure for the picture strip; and displaying the picture strip having the group of images to allow the picture strip to be visualized by a user.

In another aspect, the present application relates to a system for a camera phone user to create a photo gift. The system includes a wireless router system that can receive a data structure from a first camera phone operated by a first user, the data structure defines a picture strip that includes a row of images and has a length-to-width ratio in a range between 2.5 and 6; a storage device in communication with the wireless router system and configured to store the data structure; a server that can send a message to a recipient about the creation of picture strip; and a printing and finishing facility in communication with the server. The printing and finishing facility can produce a physical manifestation of the picture strip in accordance with the data structure, wherein the picture strip is shipped to the recipient.

In another aspect, the present application relates to a system for a user to create a personalized photo product. The system includes a server that can receive a data structure from a first computer device operated by a first user, the data structure defines a picture strip that includes a row of three or more images and has a length-to-width ratio in a range between 2.5 and 6, wherein the server can send a message to a second user about the creation of picture strip, wherein the server can receive an address from the second user; a storage device in communication with the wireless router system and configured to store the data structure; and a printing and finishing facility in communication with the server. The printing and finishing facility can produce a physical manifestation of the picture strip in accordance with the data structure, wherein the picture strip is shipped to the address provided by the second user.

In another aspect, the present application relates to a method for automatically creating a picture strip. The method includes defining a template for a picture strip on a first computer device, wherein the template can receive three or more images in a row; assigning three or more images to the template to produce the picture strip; creating a data structure for the picture strip, wherein the data structure specifies the three or more images and a length-to-width ratio in a range between 2.5 and 6; sending the data structure to a server; storing the data structure by a computer storage device in communication with the server; receiving the data structure by a second computer device from the server; and simultaneously displaying the three or more images in the picture strip on the second computer device.

Implementations of the system may include one or more of the following. The wireless router system can send the data structure to a second camera phone under the command of the first user, to allow the picture strip to be displayed on the second camera phone viewable by the recipient without editing by the recipient. The server can send the data structure as an integrated data object to a computer device, to allow the row of images in the picture strip to be simultaneously incorporated into a blog page. The picture strip can be automatically scaled to fit the layout of the blog page. The data structure can specify the recipient for the picture strip. The data structure can include data fields for image data for the row of images in the picture strip, and a width, a length, and an aspect ratio for a physical manifestation of the picture strip. The server can receive an order for a physical manifestation of the picture strip from the first user or the recipient, wherein the data structure comprises a data object for a cover strip that can display information about the order and the picture strip, wherein the cover strip is to be shipped with the physical manifestation of the picture strip. The server can receive from the recipient a physical address where the picture strip is to be sent.

Embodiments may include one or more of the following advantages. The disclosed systems and methods provide a flexible image presentation and print format that be easily created and transferred across different media forms. In one implementation, the described picture strip allows a personalized image product to be conveniently created using camera phones and other digital imaging devices, easily shared, and uploaded to a central server.

In another aspect, the disclosed systems and methods provide a convenient way for a camera phone user to create and order image-based gifts for another wireless phone user without knowing the recipient's physical address.

The disclosed systems and methods can significantly reduce the time and effort for a user to create a personalized image product. The disclosed systems and methods also provide a novel imaging product format that can be easily carried and shared by users.

### BRIEF DESCRIPTION OF THE DRAWINGS

FIG. 1 is a block diagram of a system for producing personalized image-based products.

FIG. 2 illustrates an exemplified format of a personalized picture strip.

FIG. 3 illustrates an exemplified cover strip in association of the personalized picture strip in FIG. 2.

FIG. 4 is an exemplified flow diagram for creating a personalized picture strip.

FIG. 5 illustrates a user interface for creating a picture strip.

FIG. 6 illustrates a data structure for a personalized picture strip.

FIG. 7 illustrates an example of the use of a personalized picture strip on a blog page.

FIG. 8 is a flow diagram for automatically or heuristically creating a picture strip.

Although the invention has been particularly shown and described with reference to multiple embodiments, it will be understood by persons skilled in the relevant art that various changes in form and details can be made therein without departing from the spirit and scope of the invention.

### DETAILED DESCRIPTION

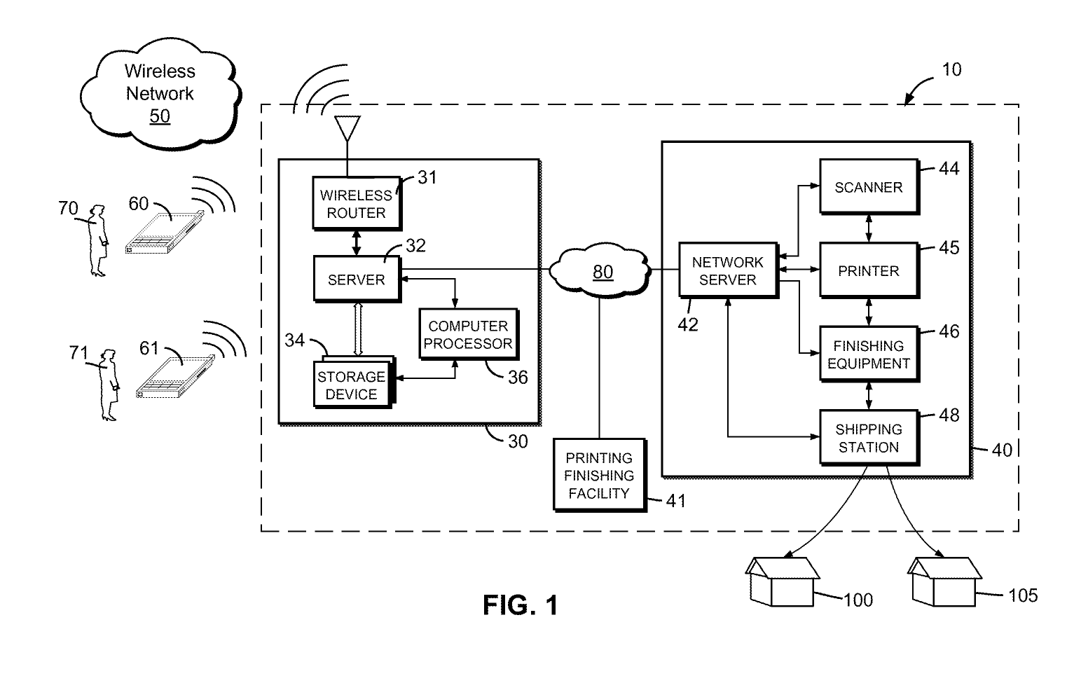

Referring to FIG. 1, a network-based imaging system 10 is established by an image service provider such as Shutterfly, Inc. to provide image services and products on a wide area network such as a wireless network 50. The network-based imaging system 10 can include a data center 30, one or more printing and finishing facilities 40 and 41, and a computer network 80 configured to facilitate communications between the data center 30 and the finishing facilities 40 and 41. The computer network 80 can include a local area network (LAN), a wide area network (WAN), and a wireless communication network.

The data center 30 can include a wireless router system 31, one or more servers 32, data storage devices 34 for storing image data, user account and order information, and one or more computer processors 36 for processing orders and rendering digital images. The wireless router system 31 may be implemented in a same device as a server 32. A photo website powered by the servers 32 can serve as a web interface. Users 70, 71 can access the photo website using camera phones 60, 61, mobile computer devices, personal digital assistance (PDA), personal computers, etc. In the present specification, the term “camera phone” refers to a mobile device that has both image capturing and wireless communicating capabilities. The term “camera phone” thus also include wireless digital camera or a PDA installed with a built-in digital camera. The wireless communications between the camera phones 60, 61 and the wireless router system 31 can be executed with the assistance of mobile phone service providers such as Verizon, AT&T, T-Mobile, etc. The wireless communications can be under various wireless standards such as such as CDMA, WCDMA, GSM, LTE, IMT-2000, WiMax, WiBro, and WiFi.

The users 70, 71 can order image-based products at web interfaces. The printing and finishing facilities 40 and 41 can manufacture the image-based products which can include image prints, greeting cards, holiday cards, post cards, picture strips, photo albums, photo calendars, photo books, photo T-shirt, photo mugs, photo aprons, image recording on compact disks (CDs) or DVDs, and framed photo prints. The image-based products can include personalized information such as users' images, personalized text, and personalized designs. In the present specification, the term “personalized” is used in personalized content, personalized messages, personalized images, and personalized designs that can be incorporated in image-based products. The term “personalized” refers to the information that is specific to the recipient, the user, the gift product, or the intended occasion. The content of personalization can be provided by a user or selected by the user from a library of content provided by the image-server provided. The content can also be provided by stock images stored at the service provider, and content licensed from a third party. The term “personalized” can also be referred to as “individualized” or “customized”, which differentiates off-the-shelf products that can be ordered without incorporating user-created or user-specific information.

The data storage devices 34 can be constructed to optimize the data accessibility, the storage reliability, and the cost. Further details on the image data storage in the network-based imaging 20 are provided in the commonly assigned U.S. Pat. No. 6,839,803, titled “Multi-Tier Data Storage System”, which is incorporated herein by reference.

The printing and finishing facility 40 or 41 can be located at the data center 30, or located remotely from the data center 30. The printing and finishing facilities 40 and 41 can be geographically located close to a large population of customers to shorten order delivery times. The printing and finishing facilities 40 and 41 and the data center 30 can be operated by different business entities. For example, a first business entity can own the data center 30 and host the photo website accessible to users 70, 71. The printing and finishing facilities 40 and 41 can be owned and operated by a second business entity that is responsible for fulfilling the image-based products ordered through at the photo website.

The order information and image data can be transferred from servers 32 to the network servers 42 using a standard or a proprietary protocol (FTP, HTTP, among others). The printers 45 can receive digital image data and control data, and reproduce images on a physical substrate. The physical substrate can be a sheet of paper, a fabric, a plastic, a metallic, or a wooden surface, etc. The printers 45 can also include digital photo printer, inkjet printer, digital presses, digital thermal dye printer, and digital laser printer. A scanner 44 can scan and digitize photographic films or prints received from users. The digital image data from the scanner 44 is stored on the data storage 34.

The printing and finishing facility 40 can include one or more network servers 42, printers 45 for printing images on physical surfaces, and finishing equipment 46 for cutting, scoring, folding, binding, punching, stapling, gluing, and other finishing operations. A shipping station 48 can perform operations such as packaging, labeling, package weighing, postage metering, order verification, and shipping image-based products to the user 70 or other recipients 100 and 105. The finishing operations can also include framing a photo print, writing image data on a CD-ROM or a DVD, making photo T-shirts, and photo mugs, etc. Furthermore, the printers 45 and the finishing equipments 46 can reside at different locations. The network server 42 can communicate with the data center 30 via the computer network 80 and facilitate the communications between different devices and stations in the printing and finishing facility 40.

After the user's digital images are received by the image service provider, the images can be hosted online at the photo website. The user 70 can view, manipulate and/or order prints in the manners described above. The user 70 can also access the photo website to create and design a photo-based product such as a photo book and a photo greeting card, and specify the images to be reproduced on an image-based product and parameters relating to printing (e.g., finish, size, number of copies). The user 70 can designate one or more recipients 100 and 105 for the order and enter payment information. The image-based products can include prints, greeting or holiday cards, books, greeting cards, playing cards, T-shirts, coffee mugs, mouse pads, key-chains, photo collectors, photo coasters, or other types of photo gift or novelty item. The image-based products are then delivered to the specified recipients 100 and 105 using U.S. Postal Service, or courier services such as Federal Express and UPS.

The user 70 can take pictures with the camera phone 60 and upload the image data to the server 32 in the network-based imaging system 10. Camera phones are usually supported by limited web interface features compared to personal computers. In addition, camera phone users may not have as much time at a user interface on a camera phone as the users use personal computers. It has been inconvenient for a user to design, create, share, and/or order a personalized image product using a camera phone.

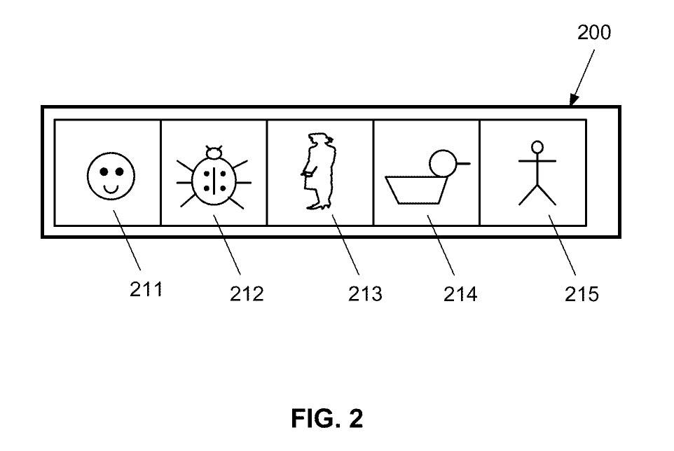

In some embodiments, referring to FIGS. 2-4, a picture strip 200 (FIG. 2) has a convenient slender print format. The picture strip 200 can have slender dimensions of 2″×5″, 2″×6″, 1.5″ by 4″ and so on, and an aspect (length to width) ratio in the range of 2.5:1 to 6:1. The picture strip can be produced a photosensitive paper, a plain paper, a substrate comprising synthetic materials such as a plastic sheet, a glass sheet, and a metal substrate. The picture strip 200 is narrower and have a higher aspect ration compared to traditional 3R (3.5″ by 5″), 4R (4″ by 6″), and 5R (5″ and 7″) print formats

The slender formats of the picture strip 200 also makes it easily carried around in a pocket, wallet, or inserted in a book or a note book. The format of the picture strip 200 is suitable for displaying a row of tiny images 211-215 in a group. These tiny pictures are suitable for displaying images captured by camera phones because some camera phones do not have large image sensors that can produce digital images at high enough resolutions for large image prints. Moreover, the users of camera phones with large image sensors may want to reduce the amount of the data wireless transferred by uploading a downsized version of the captured image to the network-based imaging system 10.

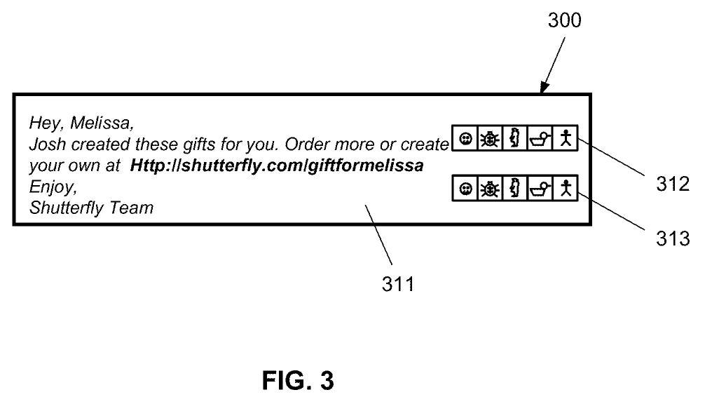

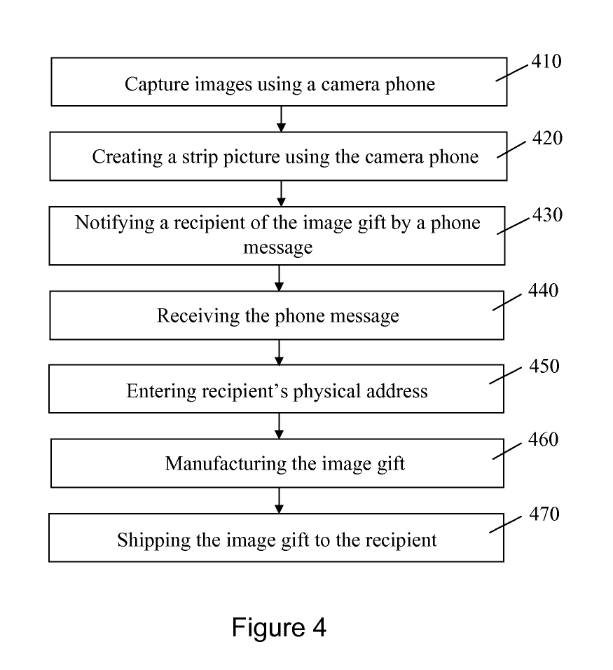

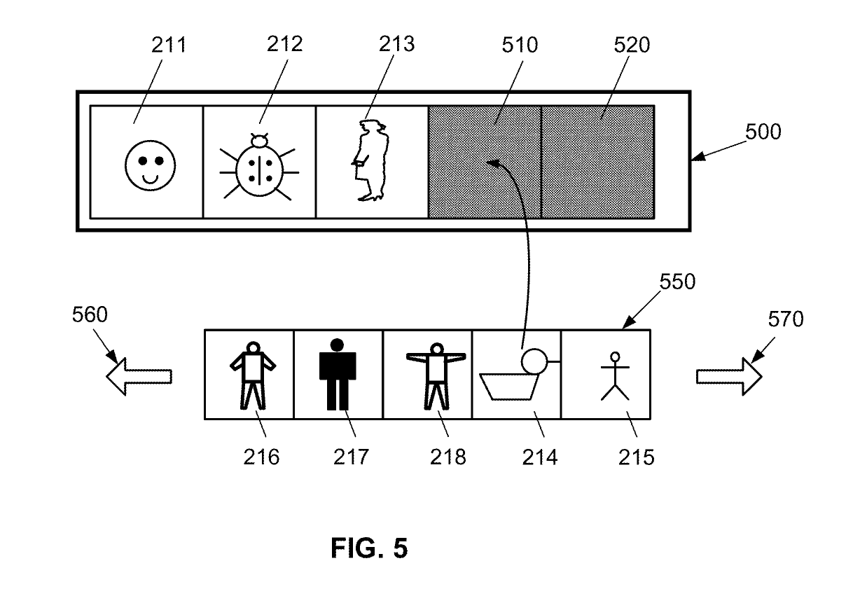

For example, Melissa and Josh have both attended a reunion party. Josh has taken a number of images at the party (FIG. 4, step 410) and likes to share the images with Melissa. To make the images into a more memorable image product, Josh can quickly select and move images 211-215 into the template of a picture strip 200 using a user interface on his camera phone (FIG. 4, step 420). For example, referring to FIG. 5, a user interface on a camera phone can include a template 500 for a picture strip (e.g. 200, shown in FIG. 2). An image storage area 550 can hold and display a plurality of images 214-218. Josh can move the images in and out of view using tough sensitive arrows 560 and 570 or by multi-touch sensing. The picture-strip template 500 can include a plurality of image receiving areas 510, 520, some of which have already received images 211-213. The user (Josh) can simply use touch sensing at the camera phone interface to drag and drop image 214 into the image receiving area 510 in the picture-strip template 500 to form the picture strip 200. If Josh knows Melissa's address, Josh can quickly order the picture strip to be produced by the photo service provider. The picture strip 200 can be shipped by the image service provider (e.g. Shutterfly, Inc.) to Melissa with a cover strip 300 (FIG. 3) that can include order information such as a message 311:
“Hey, Melissa,
Josh created these gifts for you. Order more or create
your own at Http://shutterfly.com/giftformelissa
Enjoy,
Shutterfly Team”.
   The cover strip 300 can also include representations 312, 313 of the picture strips shipped in the same gift order.

In some embodiments, the camera phone users often only have phone numbers, rather than physical addresses, of the people they want to share photos with or send photo gifts to. The disclosed network-based imaging system 10 is configured to create a short phone message from the gift creator (Josh) to the gift recipient (Melissa). The message is transmitted by the server 32 and the wireless router system 31 via the wireless network 50. For example, after the picture strip 200 (FIG. 2) is created and stored at the storage device 34 (FIG. 34), Josh can send Melissa a message over his mobile phone via the image service provider such as Shutterfly, Inc. (FIG. 4, step 430):
“Hey, Melissa,
Josh created these gifts for you. Order more or create
your own at Http://shutterfly.com/giftformelissa
Enjoy,
Shutterfly Team”.

The message can be a phone text message using a short message server (SMS), an email message, an online chat message, or other types of messages. Josh can provide payment information for the gift for Melissa to the server 32. Alternatively, the system can allow Melissa to send payment information to the server 32 after she receives the message from Josh. Upon receiving the phone message (FIG. 4, step 440), Melissa can click though the Uniform Resource Locator (URL) link in the message to enter her physical address to receive the order (FIG. 4, step 450). The physical address and the order are received by the wireless router system 31 and the server 32, and stored on the storage device 34. The image service provider can charge the order to Josh's account. Alternatively, Josh can simply create the picture strip for Melissa to order and pay in the ordering process. A physical manifestation of the picture strip is subsequently manufactured by the service provider (FIG. 4, step 460), and shipped to the physical address of the recipient (FIG. 4, step 470).

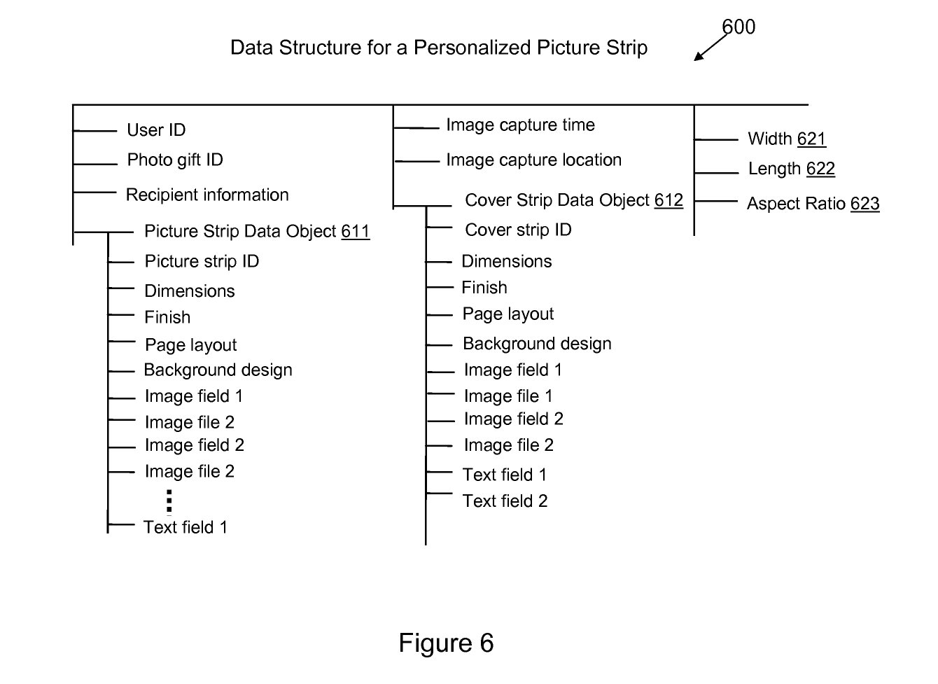

In some embodiments, a picture strip, once saved on a camera phone, can be stored in an integrated data structure that can be easily transferred between computers, mobile devices, servers, data centers, printing and finishing facility, and among different image service providers. Referring to FIG. 6, an exemplified data structure 600 can include user identification (ID), a photo gift ID, recipient's information (name, phone number, physical address if available, etc.), one or more picture strip data objects 611 each defining a picture strip in the gift, and a cover strip data object 612 defining the cover strip for the picture strips in the gift. The data structure 600 can also include capture time and location for a group of images in the picture strip or each individual image.

The picture strip data object 611 can include a picture strip ID, dimensions (e.g. 2″×6″), and finish (glossy paper, matte paper, plastic sheet, etc.) for the picture strip. The picture strip data object 611 can also include a page layout that defines how many images to be displayed on the picture strip (e.g. five images 211-215 are displayed in the picture strip 200). Background design can define a background such as a blank background, a background with solid color, a textured background, or a background with themes like romantic, sports, party, travel, vacation, etc.). The picture strip data object 611 can define a plurality of image fields (1, 2, 3 . . . ) consistent with the background, and image files associated with each image field. The picture strip data object 611 can define a text in a text field on the picture strip. Similarly, the cover strip data object 612 defines cover strip ID, dimensions, finish, page layout, and background for the cover strip. The image field can define the location and size of the miniature pictures (312, 313 in FIG. 3) of the picture strip included in the gift order, and text and reorder information from the sender or service provider to the recipient (311, FIG. 3).

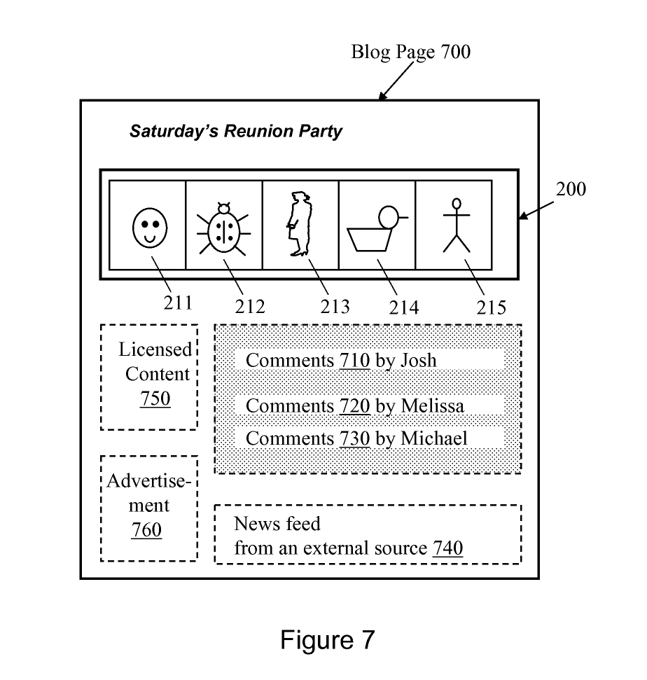

The data structure 600 defines properties for digital as well as physical manifestations of the picture strip 200. An electronic display of the picture strip 200 can be scalable to fit the layout of a user interface (such as the blog page 700 shown in FIG. 7). The data structure 600 can define a width 621, a length 622, and an aspect ratio 623 of a physical representation of the picture strip 200. The picture strip 200 for example can have slender dimensions of 2″×5″, 2″×6″, 1.5″ by 4″ and so on, and an aspect (length to width) ratio in the range of about 2.5:1 and about 6:1.

The above described data structure can be viewed as a digital encapsulation for metadata for a picture strip. The data structure defines the properties of the picture strip product to allow printing and finishing facility to manufacture (printing and cutting etc.) the picture strip according to the data structure. Moreover, the data structure can also be transferred to a computer, kiosk, or a terminal that is connected to local printer and allow the associated picture strip to be printed with the local printer.

In some embodiments, the user 70 creates a picture strip using his camera phone 60. A data structure as described above (600, FIG. 6) can be stored at the storage device 34 (FIG. 1). The user 70 can initiate at the user interface of the camera phone 60 to send the picture strip to the user 71. The sever 32 and wireless router system 31 (FIG. 1) can send the data structure to the camera phone 61. Since the data structure is an integral and comprehensive digital encapsulation of meta data for the picture strip, the picture strip can be automatically displayed on the camera phone 61 viewable by the user 71, without being edited by the user 71.

The above described data structure also allows the picture strip to be transferred as a stand-alone entity in digital and online forms in emails, on a blog page (on Facebook etc.), on a web page, or within a cell message. For example, referring to FIG. 7, the user Josh may create a blog page 700 about the reunion party he and Melissa attended. The picture strip 200 created by Josh has been uploaded to the network-based imaging system 10 operated by the image service provider. Josh can simply access his account via his wireless camera or a different Internet access device such as a personal computer. Josh can incorporate the picture strip 200 as an integrated data object on the blog page without recreating it. The picture strip 200 can include images 211-215 and text information, which are simultaneously incorporated into the blog page 700. The picture strip 200 can be automatically scaled to desired dimensions in the layout of the blog page 700.

Josh's blog page 700 can further include comments 710-730 from Josh, Melissa, Michael and others, news feed 740 from external sources, licensed content 750, and paid advertisement 760. Viewers of the blog page 700 can mark one or more picture strips as his or her favorite, and can order physical manifestations of the picture strip 200 from the image service provider by clicking on the picture strip 200 on the blog page 700.

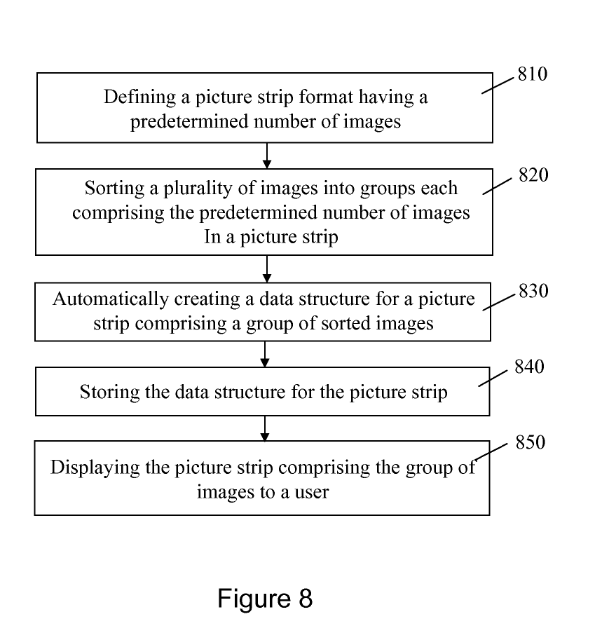

In some embodiments, picture strip can be automatically created by an algorithm or heuristically created without direct human intervention. Referring to FIG. 8, images are captured by a digital camera, a camera phone, or other image capturing devices. A picture strip format is predefined (step 810) on a web user interface, a client software, or in other imaging software applications. Each picture strip is defined with a predetermined number of images such as 3, 4, 5, 6 . . . , which can be arranged in a single row or in other layouts. The plurality of images is next sorted into groups each having the predetermined number of images in a picture strip (step 820). The sorting of the images can be conducted in a number of ways, for example, by capture time or capture location of the images because the images captured in temporal and positional proximity are likely relate to a same event. The sorting of images can also be done by color analysis. Images having the same image color distribution may also belong to the same occasion (e.g. beach scene versus an indoor party scene). The images sorted in a group are next automatically stored in a data structure for the picture strip by the algorithm running a computer processor or server (step 830). The data structure is stored (step 840). The picture strip having the group of images and associated with the data structure are next displayed to be viewed by a user (step 850). It should be noted that the systems and methods can differ from the examples above without deviating from the spirit of the present invention. The exact dimensions, materials and finish of a picture strip may vary from the examples above. In particular, the aspect ratios of picture strip are not limited to the above described examples. The images on a picture strip can be arranged in one or more rows, or in other layout. Picture strip can also be presented in many other digital forms than the examples described above.

Data structures for picture strip and cover strip are also not limited to the specific structures and data fields shown above. For example, a hierarchical or a tree-type data structure can include different levels and branches for defining picture strip and cover strips in one or several associated events. Furthermore, picture strips can be manufactured in different processes and with equipment as described above.

What is claimed is:

1. A system for a camera phone user to create a photo gift, comprising:
a wireless router system configured to receive a data structure from a first camera phone operated by a first user, the data structure defining an image-based product incorporating an image captured on the first camera phone, wherein the wireless router system is configured to send a message to a second phone operated by a second user about the image-based product and to receive a physical address from the second user;
a storage device in communication with the wireless router system and configured to store the data structure; and
a printing and finishing facility in communication with the wireless router system, the printing and finishing facility being configured to produce the image-based product in accordance with the data structure, wherein the image-based product is shipped to the physical address.

2. The system of claim 1, wherein the wireless router system is configured to send the data structure to the second phone at the request of the first user, to allow a design of the image-based product to be displayed on the second phone.

3. The system of claim 1, wherein the message is sent from the first camera phone via the wireless router system to the second phone.

4. The system of claim 1, wherein the data structure defines a picture strip that includes a row of images and has a length-to-width ratio in a range between 2.5 and 6.

5. The system of claim 1, wherein the data structure comprises a data field for the image data of the image captured by the first camera phone, and a dimension for the image-based product.

6. The system of claim 1, wherein the wireless router system is configured to receive an order for the image-based product from the first user without knowing the physical address of the second user.

7. The system of claim 1, wherein the wireless router system is configured to receive an order for the image-based product from the second user after the second user receives the message from the wireless router system.

8. A method for a camera phone user to create a photo gift, comprising:
receiving a design for an image-based gift product from an image-capture device capable of wireless communication operated by a first user, the image-based product incorporating an image captured by the image-capture device;
sending a message via a wireless router system about the image-based gift product from the first user to a second user;
receiving a physical address from the second user by the wireless router system after the message is received by the second user;
manufacturing the image-based gift product by a printing and finishing facility in communication with the wireless router system; and
shipping the image-based gift product to the physical address.

9. The method of claim 8, wherein the second user operates a wireless device, wherein the message is sent from the image-capture device via the wireless router system to the wireless device.

10. The method of claim 8, wherein the wireless router system is configured to send a design of the image-based product to the second wireless device at the request of the first user, to allow the design of the image-based product to be displayed on the second wireless device.

11. The method of claim 8, wherein the image-based product defines a picture strip that includes a row of images and has a length-to-width ratio in a range between 2.5 and 6.

12. The method of claim 8, wherein the wireless router system is configured to receive an order for the image-based product for the second user from the first user without knowing the physical address of the second user.

13. The method of claim 8, wherein the wireless router system is configured to receive an order for the image-based product from the second user after the second user receives the message from the wireless router system.

14. A method for a camera phone user to create a photo gift, comprising:
receiving a data structure from a first camera phone operated by a first user by a wireless router system, the data structure defining a design for an image-based product incorporating an image captured on the first camera phone;
sending a message from the wireless router system to a second phone operated by a second user about the image-based product;
receiving a physical address by the wireless router system from the second user using the second phone;
producing the image-based product by a printing and finishing facility in communication with the wireless router system in accordance with the data structure; and
shipping the image-based product to the physical address.

15. The method of claim 14, further comprising sending the data structure from the wireless router system to the second phone to allow the design of image-based product to be displayed on the second phone.

16. The method of claim 14, wherein the wireless router system is configured to receive an order for the image-based product for the second user from the first user without knowing the physical address of the second user.

17. The method of claim 14, wherein the wireless router system is configured to receive an order for the image-based product from the second user after the second user receives the message from the wireless router system.

18. The method of claim 14, further comprising:
allowing a template for the image-based product to be displayed on the first camera phone, wherein the template includes an image receiving area; and
receiving the image in the image-receiving area to produce the design for the image-based product.

19. The method of claim 14, wherein the image-based product comprises a picture strip that includes a row of images and has a length-to-width ratio in a range between 2.5 and 6.

20. The method of claim 14, wherein the message includes a text message, an email message, or an online chat message.
